(19) United States
(12) Patent Application Publication
(10) Pub. No.: US 2005/0225851 A1
(43) Pub. Date: Oct. 13, 2005

(54) Transmitted light bright field illuminating device

(76) Inventors: Walter Koerner, Saulheim (DE); Axel Laschke, Budenheim (DE)

Correspondence Address: STRIKER, STRIKER & STENBY, 103 EAST NECK ROAD, HUNTINGTON, NY, 11743, US

(21) Appl. No.: 11/098,190

(22) Filed: Apr. 4, 2005

(30) Foreign Application Priority Data
Apr. 10, 2004 (DE) 10 2004 017694.9

(51) Int. Cl. A61G 13/00

(52) U.S. Cl. 359/388

(57) ABSTRACT

The subject matter of the invention is a transmitted light bright field illuminating device, in particular for stereomicroscopy, having bright field luminous means which are arranged on a luminous surface and whose directions of emission lie substantially in the direction of the object to be transilluminated, which comprises measures for producing a segmented light field and which includes no beam-focusing and/or beam-deflecting measures.

The invention relates to a transmitted light bright field illuminating device and to a combined transmitted light bright field and transmitted light dark field illuminating device, to its application and to a method for transmitted light bright field illumination.

Two basic methods of illumination are distinguished in stereomicroscopy—those of reflected light and transmitted light. In reflected light illumination, the object to be examined is illuminated obliquely from above, whereas the object to be examined is transilluminated from below in the case of transmitted light illumination.

An additional distinction is made in the case of transmitted light illumination between transmitted light bright field illumination and transmitted light dark field illumination. Whereas during transmitted light bright field illumination light reaches the objective of e.g. the microscope even in the case of an examination object not located in the specimen plane, this is not so with transmitted light dark field illumination. Only with the insertion of an object into the specimen plane does the grazing light incidence from below, which originates from the transmitted light dark field illumination, lead to illumination of the edges of the object which are to be viewed through the objective.

A multiplicity of transmitted light bright field and transmitted light dark field illuminating devices are known from the prior art. The simplest transmitted light bright field illuminating device is a rotatable mirror which is located below the specimen plane. In order to transilluminate the object to be examined with transmitted light incident obliquely on one side, use is also made of rotatable mirrors which can be laterally displaced. These transmitted light bright field illuminating devices are certainly very cost effective to produce, but they have a poor light yield and a poor homogeneity of the light field. Moreover, the direction of the lateral transillumination is limited to always one angle, and this is insufficient for many objects.

DE 196 44 662 A1 describes a transmitted light bright field illuminating device in which the light source is located below the specimen plane but to the side of the object to be examined, the beams of the said device being guided to the object to be examined via an optical system and a deflecting mirror. The subject matter of DE 100 17 823 A1 and DE 37 34 691 A1 is a transmitted light bright field illuminating device in the case of which a light source constructed as an LED arrangement is located directly below the specimen plane and is imaged onto the specimen plane via an optical system comprising a number of lenses.

Fibre optic ring illuminations or the stops are frequently used as transmitted light dark field illuminating devices. These illuminating devices have the disadvantage that they are of complicated and therefore expensive design owing to the use of optical and/or fibre optic systems. Furthermore, it is possible to achieve a segmented light field only with a high outlay using the known fibre optic systems.

Transmitted light bright field illuminating devices have to date had a relatively large overall height. A large overall height of the illuminating devices is disadvantageous from ergonomic points of view, since it is added to the overall height of a microscope, for example, and the user thereof must work above the customary working height. This is frequently felt to be troublesome by the user and can cause him to be fatigued.

Illumination is particularly important in stereomicroscopy, since it is used to produce contrasts on the object to be examined by means of which structures on the object are rendered visible more effectively or even for the first time. For some objects, the transmitted light must transilluminate the object obliquely. However, it is not sufficient with many objects when the oblique transillumination is performed only at one angle.

It is therefore the object of the present invention to provide a transmitted light bright field illuminating device which is easy to produce, of low overall height, and ensures a high flexibility of the possible light incidence angles on the object to be transilluminated in conjunction with a high homogeneity of the light field. It is further the object of the present invention to provide a method for transmitted light bright field illumination of objects to be examined which permits transmitted light examinations at various light incidence angles both in the bright field and in the dark field. The objects are achieved by means of the independent claims. Preferred embodiments are the subject matter of the dependent claims.

The inventive transmitted light bright field illuminating device includes bright field luminous means which are arranged on a luminous surface, and therefore areally and whose directions of emission are substantially in the direction of the object to be transilluminated. The surface on which the bright field luminous means are fitted usually lies directly below the specimen surface. The specimen surface is the surface in the specimen plane on which the object to be examined is usually laid. In this case, the dimensions of the surface on which the bright field luminous means are arranged are selected such that the specimen surface is essentially completely illuminated. Beam-focusing measures, for example imaging optics, and/or beam-deflecting measures, for example deflecting mirrors, can be dispensed with owing to this design of the transmitted light bright field illuminating device. In order to ensure a high flexibility of the angle of light incidence on the object to be examined, the inventive transmitted light bright field illuminating device further comprises measures for producing a segmented light field. The light field is produced by superimposition of the individual light fields of the individual bright field luminous means. An unsegmented light field is produced when all the bright field luminous means emit light simultaneously, the light field always being referred in the course of the description to the specimen plane on which the object to be examined is located. An unsegmented light field accordingly corresponds to the projection of the luminous surface—that is to say the surface on which the bright field luminous means are arranged and/or mounted—onto the specimen surface. By contrast therewith, a segmented light field is produced when individual luminous means do not contribute to the transillumination of the specimen surface. As a result of a segmented light field it is possible to transilluminate the object to be examined at oblique light incidence angles.

In a preferred embodiment, the segmented light field is produced by driving bright field luminous means in a targeted manner. The measures for producing a segmented light field can therefore include suitable circuits for the luminous means. If the bright field luminous means comprise a plurality of individual light sources, this means that groups of individual light sources are preferably interconnected and simultaneously supplied with current, while the others remain unenergized and therefore dark. Segments can be driven with the aid of suitable control units such as are described, for example, in DE 203 04 412 U1.

The bright field luminous means are preferably combined into groups such that the segmented light field has the form of circular and/or annular and/or linear segments.

In an alternative preferred embodiment, the segmented light field is produced by vignetting segments of the luminous surface. The vignetting measures can comprise, for example, stops, sector stops, slit stops etc. which can be swivelled in. Also possible is a combination of driving the bright field luminous means segment by segment and vignetting the luminous surface.

If slit stops are used, it is preferably possible to set their slit width and/or their position. Horizontally displaceable slit stops which can have their slit width set have proved themselves in this case. It is likewise possible for the abovenamed slit stops to be arranged such that they can rotate in the stop plane.

Light-emitting semiconductor diodes (LEDs) are preferably used as bright field luminous means, in particular white light LEDs in this case. These are preferably arranged as a matrix and switched on segment by segment. Should the design of the LEDs include measures for focusing the light beam, these are not covered by the term of the beam-focusing measures in the meaning of the present invention. Alternatively, organic light-emitting diodes (OLEDs) are used instead of the LEDs. These can already be produced in the required form of segments, or at least include an electrode of segmented structure.

The functional design of OLEDs is sufficiently known.

In principle, they comprise a transparent substrate coated with a transparent electrode, a functional layer, applied to the transparent electrode, of a light-emitting polymer, and a metal electrode on the functional layer. Light generally exits through the transparent substrate. OLEDs have the advantage that they can be of extremely low overall height and that, by contrast with LEDs, they are surface emitters, that is to say a large area can be caused to shine simultaneously.

Since, by contrast with OLEDs, LEDs are generally not surface radiators, but rather have small light exit surfaces, a particularly preferred embodiment of the invention comprises means for homogenizing the light field produced by the bright field luminous means. The means for homogenizing the light field can comprise, for example, diffusion or ground glass plates. The use of these means ensures that individual light exit surfaces of the bright field luminous means are not emitted in the objective, and/or that the object to be examined is transilluminated uniformly, that is to say with a light field which essentially has no locally different brightness amplitudes. If OLEDs are used as bright field luminous means, the means for homogenizing the light field can likewise be advantageous, since it is known that scattering elements on the light exit side of the functional layer raise the light exit efficiency and thus the luminosity of the OLED. Another positive aspect of the use of the means for homogenizing the light field when OLEDs are used as luminous means is that the OLEDs can be produced more cost effectively in this case, since less stringent requirements can be made in relation to the homogeneity of the functional layer.

It is likewise possible that the means for homogenizing the light field can be exchanged or swivelled in separately from one another such that different diffusion plates, for example, are to be inserted between the bright field luminous means and object in accordance with the requirements.

In addition to driving and/or vignetting appropriate segments of bright field luminous means, in the case of oblique transmitted light incidence the angle can also be set by varying the distance between the bright field luminous means and the object to be examined. This can be performed in a very simple way when the transmitted light bright field illuminating device is accommodated in a housing which includes means for varying this distance. These means can comprise, for example, electric servomotors or suitable mechanical measures.

In a preferred embodiment of the invention, the distance between the luminous means and the specimen plane on which the object to be examined is located can be set in a range of between 10 mm and 95 mm.

The bright field luminous means of the transmitted light bright field illuminating device can be arranged on any desired surfaces. This comprises, for example, hemispherical inner surfaces or semicylindrical inner surfaces or sections. However, it is preferred to arrange the bright field luminous means on a plane which extends parallel to the specimen plane.

It can be necessary for some objects to perform a transmitted light dark field illumination in addition to the transmitted light bright field illumination. The transmitted light bright field illuminating device according to the invention therefore comprises in a particularly preferred embodiment additional luminous means for transmitted light dark field illumination. These can be fitted in an essentially annular fashion in the direction of the object to be transilluminated above the bright field luminous means arranged in a planar fashion. The shape of the arrangement of these dark field luminous means is, of course, dependent on the shape of the elevation of the bright field luminous surface. The dark field luminous means do not usually vignette the bright field luminous surface. LEDs have proved themselves as dark field luminous means. However, OLEDs or other luminous means can likewise be used, it being preferred in the case of the OLEDs to use measures leading to a directional emission of the OLEDs. Complications of various light means are also possible.

In a preferred embodiment, the dark field luminous means illuminate the object to be examined on the specimen plane at flat irradiation angles of at most 30°, measured from the specimen plane.

It is particularly advantageous when the transmitted light bright field illuminating device includes measures for driving the dark field luminous means segment by segment. In a way similar to that described above, this can be a suitable circuit for transmitted light luminous means. As an alternative, or in addition, it is possible in turn to vignette the dark field luminous means with the aid of suitable measures, for example stops.

It is particularly preferred for the bright field luminous means, arranged in planar fashion, and the dark field luminous means, arranged essentially in annular fashion, to be able to be driven separately. This can be achieved by suitable measures such as switching elements, for example. It is possible in this way to examine the object using only transmitted light bright field, only transmitted light dark field or mixed light illumination composed of transmitted light bright field and transmitted light dark field illumination. If the bright field and dark field luminous means are driven and/or vignetted segment by segment, mixed light illumination examinations are possible with an oblique transmitted light incidence using the illuminating device.

In a further particularly preferred embodiment, the transmitted light illuminating device comprises measures for regulating the brightness of the luminous means in order to adapt the intensity of illumination to the requirements of the object to be examined. This includes the separate regulation of the brightness of the bright field and dark field luminous means. These measures can comprise suitable drives for the luminous means. If the bright field and/or dark field luminous means are driven, for example, using the apparatus known from DE 203 04 412 U1, it is possible to simulate rotating light sources both in the bright field, in the dark field and in mixed light by driving segments sequentially. Moreover, brightness values can be specifically adapted and user settings can be stored.

The transmitted light bright field illuminating device further preferably comprises means for detecting the operating temperature of the bright field and/or dark field luminous means. These can preferably be temperature sensors. An excessively high operating temperature of the luminous means leads to overloading of the luminous means and thus to a reduction in their service life. A suitable control unit which can be connected to the illuminating device evaluates the operating temperature and, upon overshooting of a threshold value, reduces the operating current and/or the operating voltage, at least until adequate cooling has taken place. As an alternative, or in addition it is possible for an appropriate control unit to output warning signals to the user.

If only transmitted light dark field illumination is performed, it can be desired for a dark background to be located below the object to be examined. This is achieved in a further particularly preferred embodiment of the transmitted light bright field illuminating device by inserting opaque means between the bright field luminous means arranged in a planar fashion and the dark field luminous means. These opaque means can comprise, for example, blackened glass and/or plastic and/or metal plates which are swivelled in between the bright field luminous means and the dark field luminous means.

It is a substantial advantage of the transmitted light bright field illuminating device according to the present invention that the entire device can have a low overall height by dispensing with beam-shaping measures. If the illuminating device comprises means for varying the distance between the specimen plane and luminous means and if these means are integrated in the housing surrounding the illuminating device, the housing preferably has an overall height of between 10 mm and 100 mm.

If the means for varying the distance between the object to be transilluminated and luminous means are not integrated in the housing surrounding the illuminating device, or if only a relatively short range of variation is desired, the housing preferably has only an overall height of less than 80 mm, with particular preference of between 10 mm and 50 mm. It is likewise possible that the bright field luminous means and the dark field luminous means are surrounded by separate housings. In this case, the data on overall height relate to the sum of the overall heights of the individual housings. It is, of course, also possible, and covered by the present invention, that the variation in the distance between the object to be transilluminated and luminous means is performed by means which instead of being integrated in the housing or housings surrounding the luminous means are fitted outside.

The object on which the invention is based is achieved, moreover, by a method for transmitted light bright field illumination having bright field luminous means arranged on a luminous surface, in the case of which method the object to be transilluminated is transilluminated in the bright field with light which is substantially incident at an angle of incidence differing from a mainly vertical angle of light incidence. The transillumination is preferably performed at at least two angles.

When mentioned in conjunction with the incidence of light, the term “angle” is understood within the scope of the present invention as the two-dimensional angle of the incidence of light on the object to be examined. As a rule, the light is incidence not from a single punctiform light source, but from a plurality of light sources, surface emitters or segments of the same. Consequently, the term “angle” refers to the location of the mean luminance of a segment of the luminous surface. If, for example, the object to be examined is transilluminated through segments of the luminous surface which are driven in the shape of the surface of a semicircle, the result is an oblique incidence of light on the object to be examined at an angle which differs from a vertical light incidence. It would be possible, for example, to achieve a vertical light incidence if segments of the luminous surface were driven in the shape of a circular surface whose centre lies below the object to be examined.

Using the inventive transmitted light bright field illuminating device and the inventive method, it is possible to carry out transmitted light examinations with an oblique transmitted light incidence not only at one angle, but also at several angles. This so-called mixed angle transillumination can be performed by simultaneously driving more than one segment of luminous means, but also by swivelling in appropriately shaped stops or similar means for vignetting. A combination of suitable drives and vignetting means is also possible.

In a preferred embodiment of the method according to the invention, the angles of light incidence on the object to be transilluminated are determined by driving bright field luminous means segment by segment. It is particularly preferred to drive the bright field luminous means segment by segment in time intervals. A moving segmented luminous surface can thereby be simulated. If the segments of the luminous surface are driven, for example, in the shape of the previously described surface of a hemisphere, light is incident obliquely on the object to be examined, as a result of which edges of the object cast shadows and the object contrast is enhanced. Depending on the direction of the oblique light incidence, however, it can happen that some edges cast no shadows and can therefore not be detected in the transmitted light. If, however, other segments of the luminous surface are driven in a time interval, for example as if the semicircular ones were rotated by a specific angle about the centre of the circle, the user can observe another silhouette of the transilluminated object, and so previously hidden object structures can become visible. The user can freely prescribe the time intervals. This covers shifting to and fro once or repeatedly between segments of the luminous surface, or driving permanently adjacent segments with or without overlap areas of the same such that a rotating or moving light source is simulated.

A further driving pattern to be applied for the segments of the luminous surface is specifically switching annular segments on and off. If the oblique illumination is performed from a narrow annular segment, the incidence of light can produce sharp shadows of the object edges, which are sometimes not desired. By switching in further annular segments which, as it were, correspond to widening the previously described annular segment, it is possible to achieve a more diffuse transillumination and to soften an excessively strongly cast shadow.

As an alternative or in addition to driving segments of the luminous surface, the angles of light incidence on the object to be transilluminated can also be determined by inserting stops upstream of the bright field luminous means. For example if a slit stop is introduced upstream of the bright field luminous means there is a reduction in the angular range from which the transmitted light falls onto the object to be examined. By transilluminating the object with essentially parallel light it is possible, in particular, to achieve on unstained specimens a relief-type contrast which is reminiscent of the results of interference microscopy. The interference microscopy is a contrast method in optical microscopy which requires complicated illuminating and observing optics and cannot be applied in stereomicroscopy. If the stops inserted upstream of the bright field luminous means are displaced and/or rotated, the direction of incidence of the light on the object to be examined is modified, as a result of which it is possible in turn to render visible object structures previously incapable of being observed.

A further possibility is to determine the angle of light incidence on the object to be transilluminated by changing the distance between the bright field luminous means and the object to be transilluminated.

In a preferred embodiment of the method, in addition to transmitted light bright field illumination use is made at least of one transmitted light dark field illumination. This means that at least light at an angle corresponding to a transmitted light dark field illumination device contributes to the illumination of the object to be examined. This can be achieved by making use of dark field luminous means which are driven and/or vignetted segment by segment. A mixed light illumination composed of transmitted light illumination and dark field illumination is thereby performed.

It is particularly preferred in the case of the method according to the invention to be able to regulate the brightness of the illumination in accordance with the requirements of the object to be examined.

The transmitted light bright field illuminating device according to the invention is preferably used in stereomicroscopy. Machine vision applications are likewise possible in addition.

By contrast with the prior art, the transmitted light bright field illuminating device according to the invention has the advantage that it permits a multiplicity of different types of illumination. These include transmitted light examinations at different, adaptable angles, the simulation of rotating light sources, and more. Also possible are mixed light examinations from transmitted light bright field illumination and transmitted light dark field illumination. Furthermore, the transmitted light bright field illuminating device according to the invention has a low overall height, and this has ergonomic advantages for its user, as well as a good homogeneity of the light field.

The method for transmitted light bright field illumination according to the invention renders it possible to provide for stereomicroscopy a relief-type contrast which resembles the interference contrast in optical microscopy. In addition, the illumination conditions can be adapted very effectively to the requirements defined by the object to be examined by combining the light incidence angles and transmitted light bright field illumination and transmitted light dark field illumination.

The invention and advantageous refinements are explained by way of example using the following drawings.

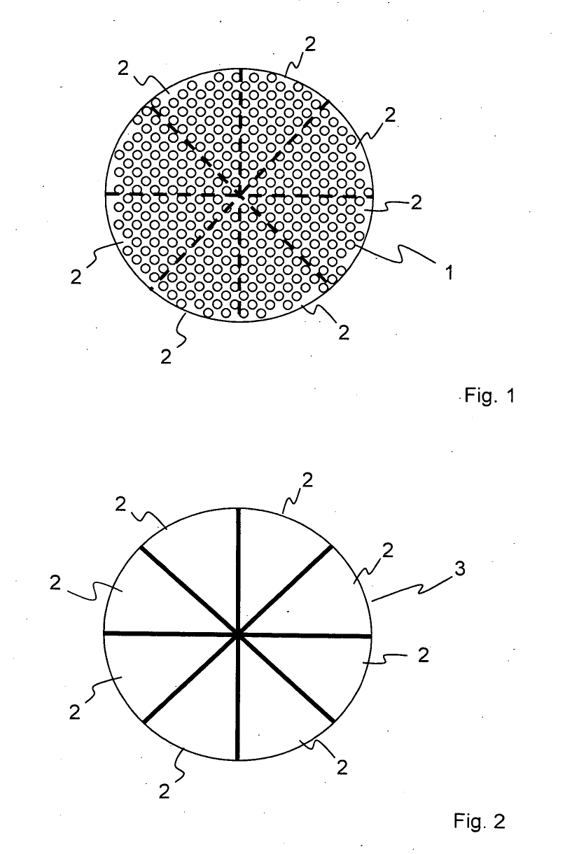

FIG. 1 shows the top view of the luminous surface of a transmitted light bright field illuminating device according to the invention. In the present example, LEDs (1) are fitted at uniform spacings on a plane with a circular contour. The broken lines mark segments (2) which can be driven separately from one another. When such a segment is driven, the LEDs (1) located in this segment (2) can be caused to shine.

FIG. 2 illustrates the top view of an OLED (3) as luminous means. The OLED occupies the entire luminous surface in this example. Marked lines indicate the structuring of the OLED (3) into segments (2). This segmentation can be performed by structuring the metal electrode and/or the transparent electrode of the OLED (3). The illustrated linear structures of the OLED luminous surface therefore symbolize non-conducting areas of the electrodes.

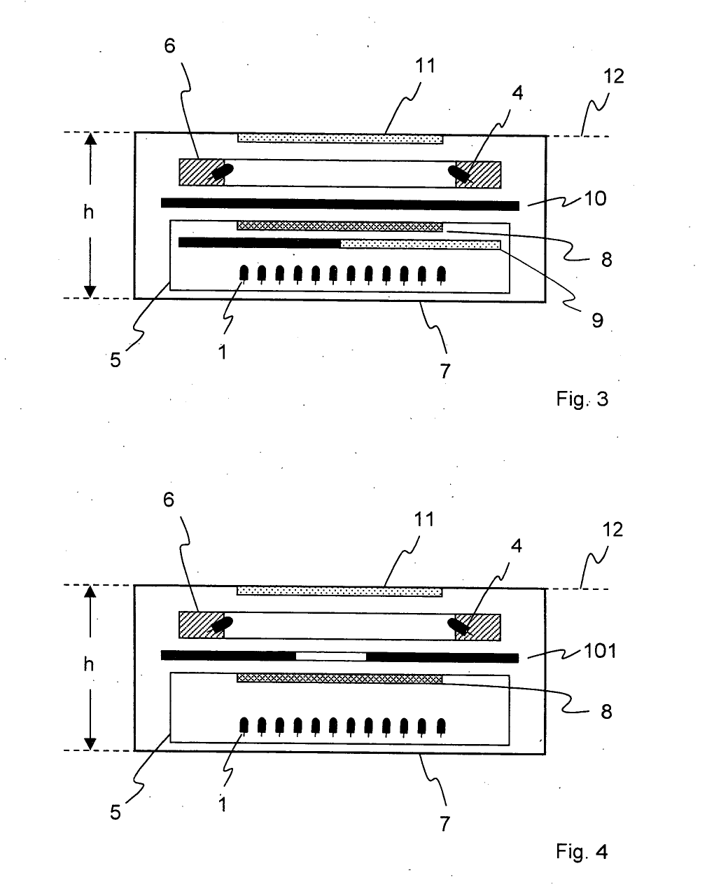

Depicted in FIG. 3 by way of example is the section through a transmitted light illuminating unit which is accommodated in a housing (7) of overall height (h). It includes a functional transmitted light bright field subassembly (5) whose luminous surface is fitted with LEDs (1) as bright field luminous means. Located above the luminous surface in the direction of the specimen plane (12) is a diffusion plate (8) which homogenizes the light field produced by the LEDs. Fitted above the transmitted light bright field subassembly (5) is an annular transmitted light dark field subassembly (6) whose purpose is to permit combined transmitted light bright field/dark field illumination examinations. LEDs are likewise used in this example as dark field luminous means (4). The object to be examined is preferably laid centrally onto the transparent surface (11), integrated in the housing (7), in the specimen plane (12). The transparent surface (11) can be a glass plate or plastic plate, for example.

If the luminous means of the transmitted light bright field subassembly (5) are not arranged and/or connected in such a way that they can be driven segment by segment, it is possible to swivel in upstream of the luminous surface a revolving disc stop (9) having at least one opaque area. The opaque areas can ensure that the object to be examined is observed at specific angles in conjunction with an oblique transmitted light incidence. It is likewise possible that the opaque areas of the revolving disc stop (9) are not completely opaque, but have only a slight transmission. It is also conceivable, moreover, that the diffusion plate (8) is equipped with areas of low transparency, and/or that the revolving disc stop (9) is not additionally swivelled towards the diffusion plate (8), but various diffusion plates with areas of low transparency are swivelled in and out in accordance with the requirements. Fitting locations of the plates (8) and/or (9) other than those illustrated are likewise also conceivable.

Furthermore, so that the object to be examined can be observed against a dark background in the case of pure transmitted light dark field illumination, it is possible for an opaque plate (10) to be swivelled in between the transmitted light bright field subassembly (5) and transmitted light dark field subassembly (7). The opaque plate (10) illustrated here can also be designed as a plate of low transparency. Fitting locations other than that illustrated are likewise possible.

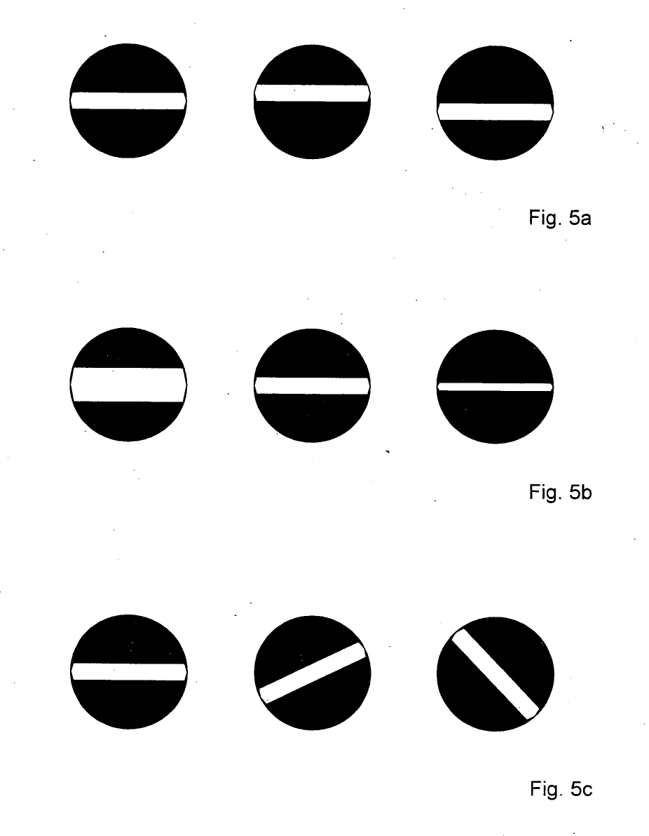

FIG. 4 shows an embodiment in which use is made of a slit stop (101) whose width can be set and whose slit can furthermore be displaced horizontally. Again, the slit stop can also be mounted rotatably. The slit stop is fitted in this embodiment above the diffusion plate (8) such that it is possible to dispense with a revolving disc stop (9) and with an opaque plate (10) if it is possible to close the slit of the slit stop (101) completely or at least sufficiently. FIGS. 5a, 5b and 5c show the top view of the slit stop (101). The bright areas symbolize the area of the stop opening through which the light emitted from the bright field luminous means enters, and which is therefore largely equivalent to the segmented light field. As already described, the illustrated segmented light field can also be implemented by the switching of corresponding segments of the bright field luminous means instead of by a slit stop.

Illustrated in FIG. 5a is the horizontal displacement of the stop slit given a constant slit width, in FIG. 5b the variation in the slit width given a constant horizontal position, and in FIG. 5c the rotation of the stop slit, again given a constant slit width. Of course, slit width, horizontal displacement and/or rotation can be combined in appropriate embodiments.

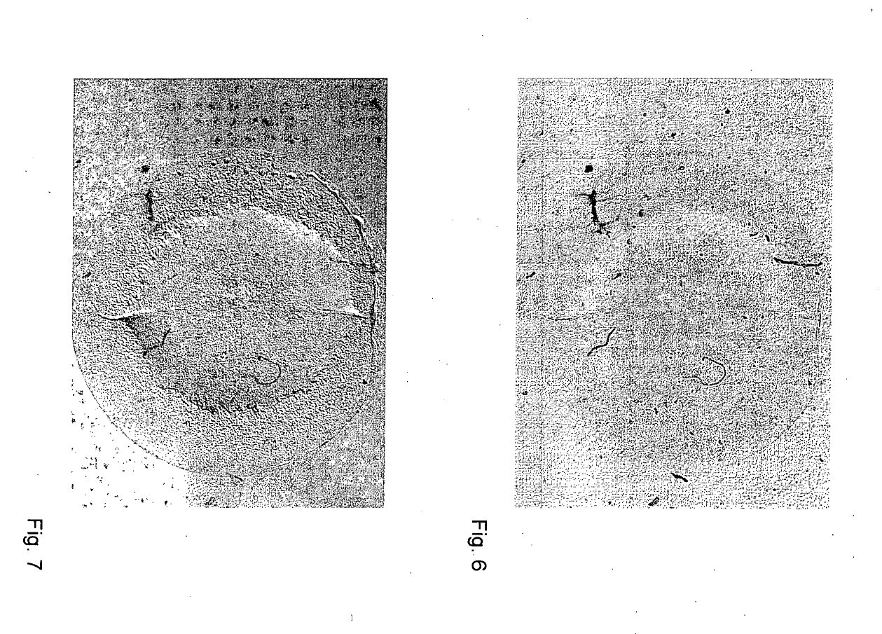

FIG. 6 shows an image obtained with a non-segmented light field of the transmitted light illuminating unit, recorded through a microscope. The transmitted light dark field illumination was not switched on in this case. All the bright field luminous means on the luminous surface were active, and so the object was transilluminated uniformly in conjunction with a largely vertical light incidence. Although in a more costly fashion, this result can likewise be achieved using the transmitted light illuminating devices from the prior art.

FIG. 7 illustrates a recording of the same object through the same microscope as in FIG. 6, but segments of the bright field luminous means were driven such that there was a mixed angle transillumination. In the present case, the segmented light field was in the shape of a semicircle. Transmitted light dark field illumination was not used for this recording. As is to be found with the aid of FIG. 7, the application of mixed angle transillumination (in the bright field) shows up the contrasts on the top side of the object much more effectively than in the case of homogeneous transmitted light bright field illumination which was used for the recording on which FIG. 6 is based. It is possible in this way to identify structures of the object which cannot be detected in FIG. 6.

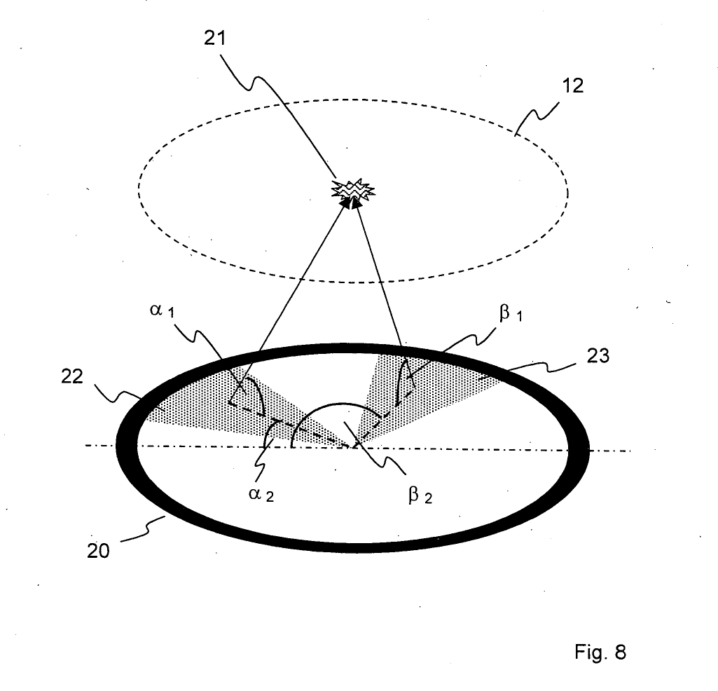

Although the reduction of a segment of the luminous surface to a single mean angle constitutes a substantial simplification, the aim is to use FIG. 8 to explain how the mixed angle illumination comes about in the bright field (20) illustrates the luminous surface on which the circular segments (22) and (23) illustrated by shading are driven, the result being cause the bright field luminous means located in these segments to shine. The object (21) to be examined on the object plane (12) is respectively transilluminated on the points of mean luminance, as it were from the luminous centroid of each segment (22) and (23). This results in light being incident at the two-dimensional angles (α₁/α₂) from segment (22) and (β₁/β₂) from segment (23), measured in each case from the plane of the luminous surface (20) or an imaginary straight line through the middle of the luminous surface (20).

1. Transmitted light bright field illuminating device, in particular for stereomicroscopy, having bright field luminous means (1, 3) which are arranged on a luminous surface and whose directions of emission lie substantially in the direction of the object to be transilluminated, which comprises measures for producing a segmented light field and which includes no beam-focusing and/or beam-deflecting measures.

2. Transmitted light bright field illuminating device according to claim 1, in which the measures for producing the segmented light field comprise measures for driving the bright field luminous means (1, 3) segment by segment.

3. Transmitted light bright field illuminating device according to claim 1, in which the segmented light field has the form of circular and/or annular and/or linear segments.

4. Transmitted light bright field illuminating device according to claim 1, in which the measures for producing the segmented light field comprise measures (9, 101) for vignetting segments (2) of the luminous surface.

5. Transmitted light bright field illuminating device according to claim 4, in which the measures for vignetting segments (2) of the bright field luminous surface comprise stops (9, 101).

6. Transmitted light bright field illuminating device according to claim 5, in which the stops are slit stops (101).

7. Transmitted light bright field illuminating device according to claim 6, in which the slit stops (101) can have their width set, and/or can be displaced horizontally and/or rotated.

8. Transmitted light bright field illuminating device according to claim 1, in which the bright field luminous means comprise a plurality of LEDs (1).

9. Transmitted light bright field illuminating device according to claim 1, in which the bright field luminous means comprise at least one organic light-emitting diode (3).

10. Transmitted light bright field illuminating device according to claim 1, having means (8) for homogenizing the light field produced by the bright field luminous means (1, 3).

11. Transmitted light bright field illuminating device according to claim 1, having means for varying the distance between bright field luminous means (1, 3) and specimen plane (12).

12. Transmitted light bright field illuminating device according to claim 1, in which the distance between the bright field luminous means (1, 3) and the specimen plane (12) is between 10 mm and 95 mm.

13. Transmitted light bright field illuminating device according to claim 1, in which the bright field luminous means (1, 3) are arranged in a plane.

14. Transmitted light bright field illuminating device according to claim 1, having additional dark field luminous means (4) which are fitted in the direction of the object to be transilluminated above the bright field luminous means (1, 3) arranged on the luminous surface.

15. Transmitted light bright field illuminating device according to claim 14, in which the dark field luminous means (4) transilluminate the object to be examined on the specimen plane (12) at an angle of at most 30° measured from the specimen plane (12).

16. Transmitted light bright field illuminating device according to claim 14 in which the dark field luminous means (4) comprise LEDs and/or organic light-emitting diodes.

17. Transmitted light bright field illuminating device according to claim 14 having measures for driving the dark field luminous means (4) segment by segment.

18. Transmitted light bright field illuminating device according to claim 14 having measures for vignetting segments of the dark field luminous means (4).

19. Transmitted light bright field illuminating device according to claim 13 having measures for separately driving the bright field luminous means (1, 3) arranged on the luminous surface, and for driving the dark field luminous means (4).

20. Transmitted light bright field illuminating device according claim 1, having measures for regulating the brightness of the luminous means (1, 3, 4).

21. Transmitted light bright field illuminating device according to claim 1, having means for detecting the operating temperature of the luminous means (1, 3, 4).

22. Transmitted light bright field illuminating device according to claim 1, having opaque means (10) which are inserted between the areally arranged luminous means (1, 3) and the essentially annularly arranged dark field luminous means (4).

23. Transmitted light bright field illuminating device according to claim 1, in which the transmitted light bright field illuminating device is surrounded by a housing (7) whose overall height (h) is between 10 mm and 100 mm.

24. Transmitted light bright field illuminating device according to claim 23, in which the housing (7) has an overall height of between 10 mm and 50 mm.

25. Method for transmitted light bright field illumination, in particular stereomicroscopy, the bright field luminous means (1, 3) being arranged on a luminous surface, and the object to be transilluminated being transilluminated in the bright field with light which is substantially incident at an angle differing from a mainly vertical angle of light incidence.

26. Method according to claim 25, in which the object to be transilluminated is transilluminated in the bright field with light which is substantially incident at at least two angles.

27. Method according to claim 25
in which the angle of light incidence on the object to be transilluminated is determined by driving bright field luminous means (1, 3) segment by segment.

28. Method according to claim 27, in which the bright field luminous means (1, 3) are driven segment by segment in time intervals.

29. Method according to claim 25
in which the angle of light incidence on the object to be transilluminated is determined by inserting stops (9, 101) upstream of the bright field luminous means (1, 3).

30. Method according to claim 29, in which the stops (9, 101) are displaced and/or rotated during the transillumination of the object to be examined.

31. Method according to claim 25
in which the angle of light incidence on the object to be transilluminated is determined by varying the distance between the bright field luminous means (1, 3) and the object to be transilluminated.

32. Method according to claim 25
in which in addition to transmitted light bright field illumination (5) use is made at least of one transmitted light dark field illumination (6) having dark field luminous means.

33. Method according to claim 25
in which the brightness of the bright field and/or dark field luminous means (1, 3, 4) is regulated.

34. Use of the transmitted light bright field illuminating device according to claim 1 in stereomicroscopy.

35. Use of the transmitted light bright field illuminating device according to claim 1 for machine vision applications.
